(19) United States
(12) Patent Application Publication
(10) Pub. No.: US 2019/0137632 A1
(43) Pub. Date: May 9, 2019

(54) REAL-TIME AUTOMOTIVE DRIVER BEHAVIOR

(71) Applicant: Daniel John DeCiccio, Winter Park, FL (US)

(72) Inventor: Daniel John DeCiccio, Winter Park, FL (US)

(21) Appl. No.: 16/178,176

(22) Filed: Nov. 1, 2018

Related U.S. Application Data
(60) Provisional application No. 62/580,250, filed on Nov. 1, 2017.

(51) Int. Cl. G01S 19/52; G06F 16/9535; G06Q 40/08; G01S 19/42; G01S 17/58; G01S 13/58

(52) U.S. Cl. CPC G01S 19/52; G06F 16/9535; G01S 13/58; G01S 19/42; G01S 17/58; G06Q 40/08

(57) ABSTRACT

A method and apparatus for real-time automotive driver behavior. A system includes a first automotive vehicle, the first automotive vehicle including a real-time driver behavior device, a second automotive vehicle, and a remote server connected to the real-time driver behavior device by a communications link, the server including at least a searchable database configured to receive information from the real-time driver behavior device.

### CROSS REFERENCE TO RELATED APPLICATIONS

This application claims benefit from U.S. Provisional Patent Application Ser. No. 62/580,250, filed Nov. 1, 2017, which is incorporated by reference in its entirety.

### BACKGROUND OF THE INVENTION

The present invention relates generally to automotive vehicles, and more specifically to real-time automotive driver behavior.

Auto insurance companies generally make judgments regarding a driver's risk based on factors available in the public record, such as, for example, auto accident records, traffic violations, and prior claims. Insurance companies have also experimented with on-board electronic trackers which a driver simply plugs into their car to help determine an individual drivers risk. For example, an automotive plug-in module may record information such as speed, acceleration etc. and upload this data to the insurance company. If the data indicates the driver is safe, the driver may receive a discount on their premiums.

What is needed is a central database of behavior of drivers in real-time.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for mobile application development and deployment.

In general, in one aspect, the invention features a system including a first automotive vehicle, the first automotive vehicle including a real-time driver behavior device, a second automotive vehicle, and a remote server connected to the real-time driver behavior device by a communications link, the server including at least a searchable database configured to receive information from the real-time driver behavior device.

In another aspect, the invention features a method including providing an automotive vehicle with a real-time driver behavior device, the real-time driver behavior device including at least a radar/laser or optical module, a Global Positioning System (GPS) module, a license plate scanner module, a proximity sensor module and a computer system, determining a license plate number of an adjacent moving vehicle with the radar/laser or optical module, determining a speed and location of the automotive vehicle, determining a separation between the automotive vehicle and the adjacent moving vehicle, and storing the license plate number, speed and location and separation in the computer system.

Embodiments of the invention may have one or more of the following advantages.

A simple add-on device to an automobile collects information of surrounding vehicles, uploads the collected information to a central database and constantly updates the central database with collected data and analyzes data to create profiles of each unique driver's behavior. This enables insurance companies to access a more complete profile of a driver's habits to ensure rates are properly chosen as well as give other interested parties ranging from attorneys and law enforcement to concerned parents a method of verifying safe driving behaviors.

A low cost, unobtrusive method of gathering driving data on large numbers of vehicles that can track various information ranging from driving safety data to location data on a wide number of vehicles.

A searchable database allows for automatic analysis and decision making from collected data. The data is useful in a variety of applications ranging from auto insurance to law enforcement and vehicle design and manufacture.

The present system uses real driver data to predict risky driving as opposed to questionnaires and other soft data.

The present system can be used to make predictions/conclusions about aggressive/unsafe driving, behaviors bases on car model/make.

Profiles used in the present invention involve categorizing aggressive and/or unsafe driving behaviors from speeding, lane changing frequency, red light running.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram.

FIG. 2 is a block diagram.

FIG. 3 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Described herein is a method or methods of gathering real time driver behavior data which is analyzed and stored in a remote database for later access.

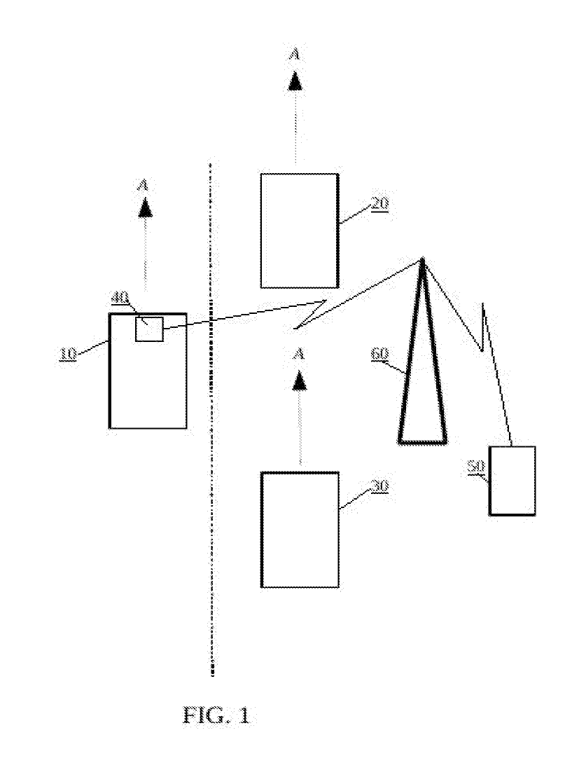

As shown in FIG. 1, an exemplary real-time driver behavior system 5 includes three automobiles 10, 20, 30 traveling in a direction generally indicated by A. Although three automobiles are shown, the system may include any number and/or type of automotive vehicle, such as a car, motorcycle and/or truck.

While not shown, each of the automobiles 10, 20, 30 includes a front and rear license plate, as is required in the majority of jurisdictions throughout the world. In addition, automobile 10 includes a real-time driver behavior device 40. The real-time behavior device 40 is configured to communicate with a remote server 50. In the exemplary real-time driver behavior system 5, communication between the real-time behavior device 40 and the remote server 50 is a wireless communication using one or more exemplary cellular towers 60. In other implementations, an app on a smartphone can facilitate communication of real time behavior.

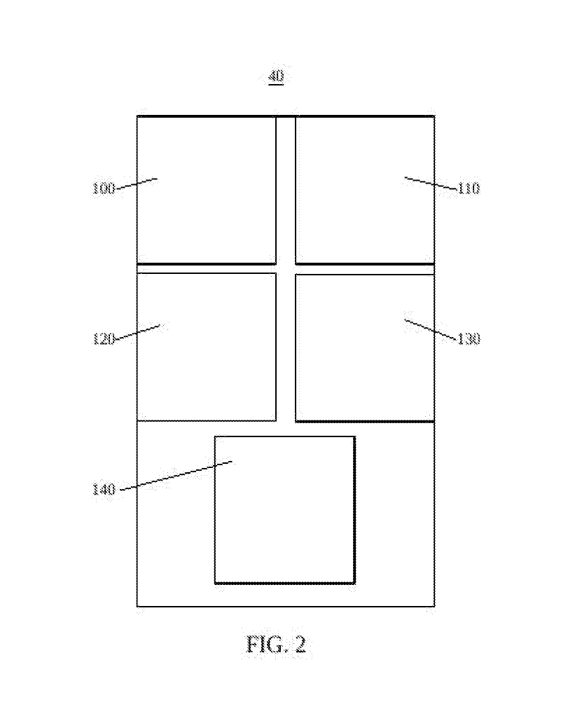

As shown in FIG. 2, the real-time driver behavior device 40 includes at least a radar/laser or optical module 100, a Global Positioning System (GPS) module 110, a license plate scanner module 120, a proximity sensor module 130 and a computer system 140.

The radar/laser or optical module 100 monitors the speed of surrounding automobiles 20, 30. The radar/laser or optical module 100 establishes the speed of at least the vehicle 20 in front of the automobile 10 to which the real-time driver behavior device 40 is affixed. A relative speed measure is taken and then cross-referenced to the speed of automobile 10 to determine the absolute speed of the vehicles measured. The data acquired by the radar/laser or optical module 100 is uploaded by the computer system 140 to a master database resident in or associated with the remote server 50 in real time or as soon as possible and compared to known geographical speed limits to determine if the cars viewed are exceeding the speed limits. In other implementations, the radar/laser or optical module 100 may be mounted in the rear of a vehicle to track vehicles to the rear.

The GPS module 110 records a location and speed of automobile 10 to ensure the speed determinations and locations are accurate for other measurements. In addition, GPS data indicates when and where other cars were when data was recorded this data could later be used to verify accuracy of the data.

The license plate scanner module 120 facilitates the optical scanning of a license plate on a proximate automobile 20, 30. The scan is used to associate driving data in the master database of the remote server 50 with a particular vehicle. Although multiple individuals may operate the same vehicle, other methods may be used to determine who was driving when (such as a phone based app system) to give even greater specificity. The master database may reference particular license plates to public vehicle registration data to establish who is responsible for the vehicle in question. In addition, various algorithms may be employed to determine a license plate and its alphanumeric markings from images taken from the license plate scanner module 120, which can operate under various conditions, such as night, rain, and so forth.

The proximity sensor module 130, such as magnetic ranging, radar, ultrasonic, time of flight, and so forth, may be employed to determine car-car separation as well as proximity to other vehicles. This may be used in conjunction with other sensors or separately to determine if a vehicle is rapidly accelerating/decelerating, changing lanes too frequently, and so forth.

The computer system 140 collects information gathered by the radar/laser or optical module 100, the Global Positioning System (GPS) module 110, the license plate scanner module 120 and the proximity sensor module 130 and uploads this data via a cell network, WiFi, hardwired connection, cell phone based, or other methods, to the master database in the remote server 50, where the data is recorded and processed.

The master database in the remote server 50 is a searchable database where the information from above is transmitted to and can be analyzed and reviewed. The master database may be a cloud based system which intakes the data above and uses the raw data to decide if a particular driver has broken driving laws or is an unsafe driver. The database may save information and determine if a driver is safe/unsafe or simply compile the driving records of vehicles encountered by the system. In some implementations, various algorithms and artificial intelligence systems may be employed to determine if a driver's past behaviors are indicative of future behaviors.

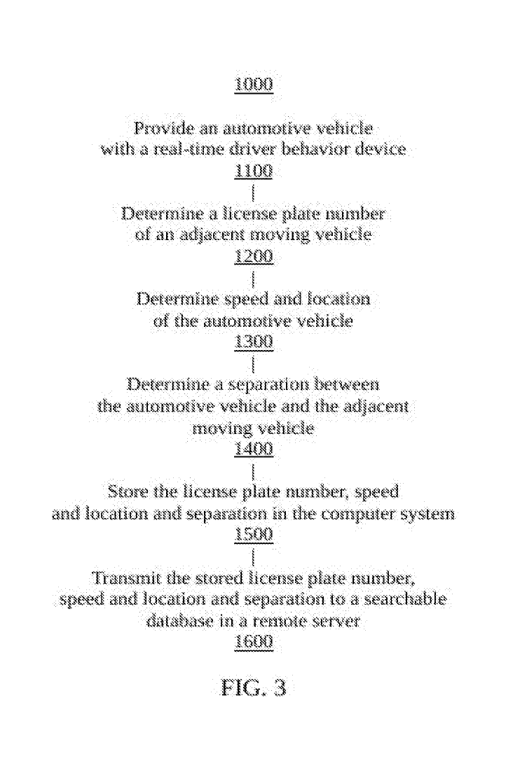

As shown in FIG. 3, a process 1000 includes providing (1100) an automotive vehicle with a real-time driver behavior device, the real-time driver behavior device including at least a radar/laser or optical module, a Global Positioning System (GPS) module, a license plate scanner module, a proximity sensor module and a computer system.

Process 1000 determines (1200) a speed of an adjacent moving vehicle with the radar/laser or optical module.

Process 1000 determines (1300) speed and location of the automotive vehicle.

Process 1000 determines (1400) a separation between the automotive vehicle and the adjacent moving vehicle. In some implementations, the separation between the vehicle and marked lanes/lines may be used to determine swerving/changing lanes.

Process 1000 stores (1500) the license plate number, speed and location and separation(s) in the computer system.

Process 1000 transmits (1600) the stored license plate number, speed and location and separation to a searchable database in a remote server.

The real-time driver behavior system 5 described above is a low-cost method of creating a database which may be updated in real-time of the driving behaviors of various drivers on the road. The real-time driver behavior system 5 is minimally invasive/lightweight, i.e., much smaller/more limited than sensors for autonomous vehicles. The real-time driver behavior system 5 may be mounted to the dashboard of cars or on the exterior of the car itself in places such as the front or rear license plate brackets. The real-time driver behavior system 5 may make use of technologies already built inside of cars which can be used to gather driver data. such as Subaru's Eyesight™ technology or Tesla's Autopilot™ system. The data may be transmitted from an embedded system or from an associated smart-phone or infotainment system. The searchable master database ensures there is easily accessible data from. The master database generated allows various interested parties to determine the driving habits of individuals. It provides tools and user interfaces to consumers of the data to easily aggregate behaviors across different pivots including location and determine risk of individual drivers by license plate

The real-time driver behavior system 5 makes use of networks effects. For example, a single vehicle with the real-time driver behavior system 5 may see and record data on hundreds of other vehicles on a single drive. Multiple cars with this real-time driver behavior system 5 will rapidly see hundreds if not thousands of vehicles and build an expansive master database rapidly of vehicle behavior. Companies may offer discounts if drivers use the above described real-time driver behavior system 5 to further aid adoption or mandate employees (such as truck drivers) have the real-time driver behavior system 5 installed on their vehicle.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A system comprising:
a first automotive vehicle, the first automotive vehicle including a real-time driver behavior device;
a second automotive vehicle; and
a remote server connected to the real-time driver behavior device by a communications link, the server including at least a searchable database configured to receive information from the real-time driver behavior device.

2. The system of claim 1 wherein the real-time driver behavior device comprises:
a radar/laser or optical module;
a Global Positioning System (GPS) module;
a license plate scanner module;
a proximity sensor module; and
a computer system.

3. The system of claim 2 wherein the radar/laser or optical module is configured to determine a speed of the second automotive vehicle.

4. The system of claim 2 wherein the Global Positioning System (GPS) module is configured to determine a speed and a location of the first automotive vehicle.

5. The system of claim 2 wherein the license plate scanner module is configured to determine a license plate number of the second automotive vehicle.

6. The system of claim 2 wherein the proximity sensor module is configured to determine a separation between the first and second automotive vehicles and a separation between adjacent vehicles and marked lanes.

7. The system of claim 2 wherein the computer system is configured to collect data from the radar/laser or optical module, the Global Positioning System (GPS) module, the license plate scanner module, and the proximity sensor module and transmit it to the searchable database in the remote server.

8. A method comprises:
providing an automotive vehicle with a real-time driver behavior device, the real-time driver behavior device including at least a radar/laser or optical module, a Global Positioning System (GPS) module, a license plate scanner module, a proximity sensor module and a computer system;
determining a license plate number of an adjacent moving vehicle with the radar/laser or optical module;
determining a speed and location of the automotive vehicle;
determining a separation between the automotive vehicle and the adjacent moving vehicle; and
storing the license plate number, speed and location and separation in the computer system.

9. The method of claim 8 further comprising transmitting the stored license plate number, speed and location and separation to a searchable database in a remote server.
